(19) United States
(12) Patent Application Publication
(10) Pub. No.: US 2026/0221332 A1
(43) Pub. Date: Jul. 30, 2026

(54) INDUCTOR AND MANUFACTURING METHOD THEREFOR

(71) Applicant: Shenzhen Sunlord Electronics Co., Ltd., Shenzhen (CN)

(72) Inventor: Wenjie WANG, Shenzhen (CN)

(73) Assignee: Shenzhen Sunlord Electronics Co., Ltd., Shenzhen (CN)

(21) Appl. No.: 19/629,246

(22) Filed: Mar. 26, 2026

Related U.S. Application Data
(63) Continuation of application No. PCT/CN2024/106202, filed on Jul. 18, 2024.

(30) Foreign Application Priority Data
Sep. 26, 2023 (CN) 202311267984.5

(51) Int. Cl. H01F 27/28; H01F 27/29; H01F 27/32; H01F 41/04; H01F 41/12

(52) U.S. Cl. CPC H01F 27/2804; H01F 27/29; H01F 27/324; H01F 41/041; H01F 41/12; H01F 2027/2809

(57) ABSTRACT

An inductor includes a main body, a first outer electrode and a second outer electrode. The main body includes multiple base layers sequentially stacked, and each includes a first insulating layer, an electrode layer and a second insulating layer. The second insulating layer is provide on the first insulating layer, located on the same surface of the first insulating layer as the electrode layer, and the second insulating layer has a gap distributed on a peripheral side of the electrode layer, the distance from the gap to the peripheral side surface of the electrode layer being d1, and d1≥10 μm, with the gap filled with a low-dielectric-constant medium.

### CROSS-REFERENCE TO RELATED APPLICATIONS

This application is a continuation of International Application No. PCT/CN2024/106202, filed on Jul. 18, 2024, which claims priority to Chinese Patent Application No. 202311267984.5, filed on Sep. 26, 2023. The disclosures of the above-mentioned applications are hereby incorporated by reference in their entireties.

### TECHNICAL FIELD

The present disclosure relates to an inductor and a manufacturing method therefor.

### BACKGROUND

In the related technologies, inductors generally have two types of structures: horizontal and vertical. Among them, horizontal inductors have high current capacity but low self-resonant frequency, while vertical inductors have low current capacity but high self-resonant frequency. To achieve an inductor that combines both high current and high self-resonant frequency, the existing approaches adopt low-permeability ferrite materials in horizontal inductors to increase the self-resonant frequency. However, this results in a problem of a narrow impedance bandwidth failing to satisfy both low-frequency and high-frequency impedance requirements simultaneously. For vertical inductors, the current can be enhanced by increasing the number of electrode turns, but this leads to problems of complex structures and low manufacturing yield.

That is, existing inductors can hardly achieve high current and high self-resonant frequency while avoiding the problems of narrow impedance bandwidth, complex structure, and low manufacturing yield.

### SUMMARY

In the prior art, it is difficult for inductors to achieve both high current and high self-resonant frequency, while avoiding the problems of narrow impedance bandwidth, complex structure and low manufacturing yield.

According to various embodiments disclosed in the present disclosure, an inductor and a manufacturing method therefor are provided.

An inductor comprises:
a main body, wherein the main body includes multiple base layers stacked in sequence, each of the base layers includes a first insulating layer, an electrode layer, and a second insulating layer, the electrode layer is disposed on the first insulating layer, the electrode layer of each of the base layers is electrically connected in sequence to form an inner electrode, the second insulating layer is disposed on the first insulating layer and located on the same surface of the first insulating layer as the electrode layer, the second insulating layer includes a gap, which is distributed on a peripheral side of the electrode layer, a distance from the gap to the peripheral side surface of the electrode layer is d1, where d1≥10 μm, and the gap is filled with a low dielectric constant medium;
a first outer electrode disposed at one end of the main body, the first outer electrode being electrically connected to the inner electrode; and
a second outer electrode disposed at an end of the main body opposite to the first outer electrode, the second outer electrode being electrically connected to the inner electrode. A manufacturing method of an inductor comprises:

providing multiple first insulating layers;
forming an electrode layer, a second insulating layer, and a low-dielectric-constant medium on one surface of each of the first insulating layers, the low-dielectric-constant medium is distributed on a peripheral side of the electrode layer, and a distance from the low dielectric constant medium to a peripheral side surface of the electrode layer is d1, where d1≥10 μm;
stacking the multiple first insulating layers formed with the electrode layer, the second insulating layer, and the low dielectric constant medium in sequence to form a main body, and the electrode layer formed on each of the first insulating layers is electrically connected in sequence to form an inner electrode;
providing a first outer electrode and a second outer electrode, and disposing the first outer electrode and the second outer electrode on two opposite sides of the main body respectively, wherein the first outer electrode is electrically connected to the inner electrode, and the second outer electrode is electrically connected to the inner electrode.

Other features and advantages of the present disclosure will be set forth in the following description, and in part will be apparent from the description, or may be learned by implementation of the present disclosure. The objectives and other advantages of the present disclosure may be realized and attained by the structures particularly pointed out in the description, the claims and the accompanying drawings. The details of one or more embodiments of the present disclosure are set forth in the accompanying drawings and the description below.

To make the above objectives, features and advantages of the present disclosure more comprehensible, preferred embodiments accompanied with the accompanying drawings are described in detail below.

### BRIEF DESCRIPTION OF THE DRAWINGS

The accompanying drawings here are incorporated into and constitute a part of this specification, illustrate embodiments consistent with the present disclosure, and together with the description serve to explain the principles of the present disclosure.

To more clearly illustrate the technical solutions in the embodiments of the present disclosure or the prior art, the accompanying drawings necessary for the description of the embodiments or the prior art will be briefly introduced below. Obviously, for those of ordinary skill in the art, other drawings can be obtained based on these drawings without creative effort. In the drawings:

FIG. 1 is a schematic structural diagram of an inductor disclosed in one or more embodiments of the present disclosure;

FIG. 2 is an exploded schematic structural diagram of an inductor disclosed in one or more embodiments of the present disclosure;

FIG. 3 is a schematic structural diagram of a base layer disclosed in one or more embodiments of the present disclosure;

FIG. 4 is a comparison diagram of impedance spectra of a comparative example and an embodiment disclosed in one or more embodiments of the present disclosure;

FIG. 5 is a schematic structural diagram of a main body disclosed in one or more embodiments of the present disclosure;

FIG. 6 is a schematic structural diagram of A-A cross-section in FIG. 3;

FIG. 7 is a schematic flow chart of a manufacturing method of an inductor disclosed in one or more embodiments of the present disclosure;

FIG. 8 is a schematic structural diagram of a first insulating layer disclosed in one or more embodiments of the present disclosure;

FIG. 9 is a schematic structural diagram of the first insulating layer formed with an electrode layer, a second insulating layer and a low dielectric constant medium disclosed in one or more embodiments of the present disclosure;

FIG. 10 is a schematic structural diagram of the first insulating layer formed with an electrode layer and a second insulating layer disclosed in one or more embodiments of the present disclosure;

FIG. 11 is a schematic structural diagram of the first insulating layer formed with a low dielectric constant medium disclosed in one or more embodiments of the present disclosure;

FIG. 12 is a schematic structural diagram of a main body disclosed in one or more embodiments of the present disclosure;

FIG. 13 is a schematic flow chart of another manufacturing method of an inductor disclosed in one or more embodiments of the present disclosure;

FIG. 14 is a schematic structural diagram of the first insulating layer formed with an electrode layer, a second insulating layer and a first medium disclosed in one or more embodiments of the present disclosure; and

FIG. 15 is a schematic structural diagram of a main body (with part of the base layers omitted) disclosed in one or more embodiments of the present disclosure.

### DETAILED DESCRIPTION OF THE EMBODIMENTS

In order to understand the above objectives, features and advantages of the present disclosure more clearly, a further description of the solutions of the present disclosure will be provided below. It should be noted that the embodiments of the present disclosure and the features in the embodiments may be combined with each other where there is no conflict.

In the following description, numerous specific details are set forth to provide a thorough understanding of the present disclosure. However, the present disclosure may also be practiced in other ways different from those described herein. Obviously, the embodiments in the specification are only some, not all, embodiments of the present disclosure.

The terms “first”, “second” and the like in the description and claims of the present disclosure are used to distinguish different objects rather than to describe a specific order of the objects. For example, a first camera and a second camera are not used to describe a specific order of the cameras, but to distinguish different cameras.

In the embodiments of the present disclosure, the words such as “exemplary” or “for example” are used to represent examples, instances or illustrations. Any embodiment or design solution described as “exemplary” or “for example” in the embodiments of the present disclosure should not be construed as preferred or advantageous over other embodiments or design solutions. Rather, the use of words such as “exemplary” or “for example” is intended to present relevant concepts in a concrete manner. In addition, in the description of the embodiments of the present disclosure, unless otherwise specified, the term “multiple” means two or more.

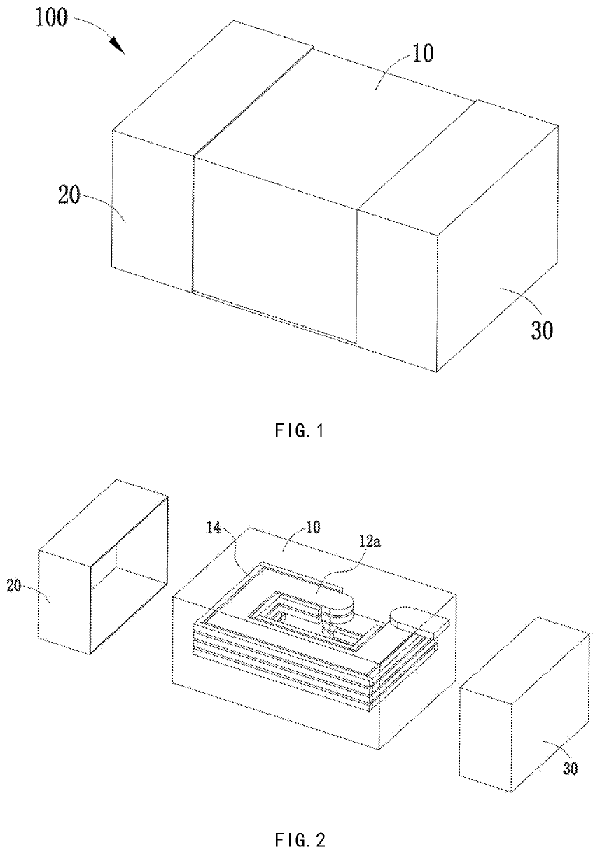

Please refer to FIGS. 1 to 3, which are schematic structural diagrams of an inductor 100 provided in one or more embodiments of the present disclosure. The inductor 100 includes a main body 10, a first outer electrode 20 and a second outer electrode 30. The main body 10 includes multiple base layers 10a stacked in sequence. Each base layer 10a includes a first insulating layer 11, an electrode layer 12 and a second insulating layer 13. The electrode layer 12 is disposed on the first insulating layer 11. The electrode layer 12 of each base layer 10a is electrically connected in sequence to form an inner electrode 12a. The second insulating layer 13 is disposed on the first insulating layer 11 and located on the same surface of the first insulating layer 11 as the electrode layer 12. The second insulating layer 13 includes a gap 13a, which is distributed on a peripheral side of the electrode layer 12. The distance from the gap 13a to a peripheral side surface 121 of the electrode layer 12 is d1, where d1≥10 μm. The gap 13a is filled with a low dielectric constant medium 14. The first outer electrode 20 is disposed on one side of the main body 10 and is electrically connected to the inner electrode 12a. The second outer electrode 30 is disposed on the side of the main body 10 opposite to the first outer electrode 20 and is electrically connected to the inner electrode 12a.

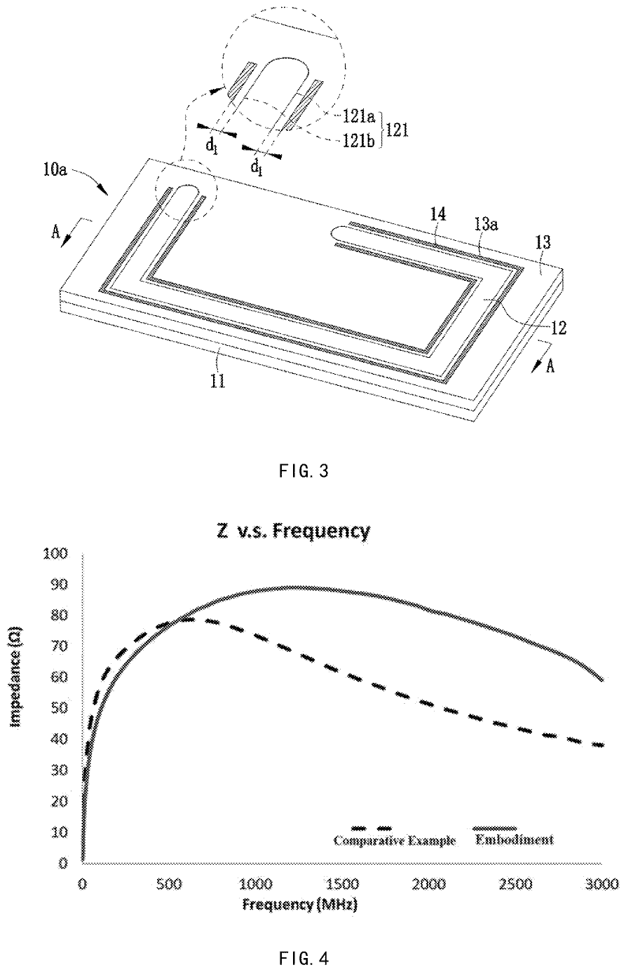

As shown in FIG. 3, to facilitate distinction between the electrode layer 12, the second insulating layer 13 and the low dielectric constant medium 14, the low dielectric constant medium 14 is hatched in the cross-section in FIG. 3. As in other views, this is only for better illustrating the low dielectric constant medium 14, and will not be repeated in the following.

In this embodiment, by disposing the electrode layer 12 and the second insulating layer 13 on the first insulating layer 11 of the base layer 10a, and disposing multiple of base layers 10a in stacked layers in sequence, so that the electrode layer 12 of each base layer 10a is electrically connected in sequence to form the inner electrode 12a, and furthermore, by electrically connecting the first outer electrode 20 and the second outer electrode 30, which are respectively disposed at both ends of the main body 10, to the inner electrode 12a to achieve electrical conduction, that is, the inductor 100 is provided, which adopts a horizontal structure, has a large current, a relatively simple structure and a high manufacturing yield. Meanwhile, the gap 13a of the second insulating layer 13 is filled with the low dielectric constant medium 14 to reduce the parasitic capacitance between the inner electrode 12a and the first and second outer electrodes 20 and 30, so that the self-resonant frequency and bandwidth of the inductor 100 are improved. That is, the inductor 100 of this embodiment can achieve both high current and high self-resonant frequency, and has a wider impedance bandwidth, a relatively simple structure and a relatively high manufacturing yield.

In addition, the distance d1 from the gap 13a of the second insulating layer 13 to the peripheral side surface 121 of the electrode layer 12 is not less than 10 μm. A part of the second insulating layer 13 can be used to separate the electrode layer 12 from the gap 13a, thereby preventing foreign matter (such as water vapor or plating solution during the manufacturing process) from entering the gap 13a and affecting the performance of the electrode layer 12, which results in a relatively high reliability of the inductor 100.

Optionally, as shown in FIG. 3, the distance d1 from the gap 13a of the second insulating layer 13 to the peripheral side surface 121 of the electrode layer 12 may be 10 μm, 12 μm, 14 μm, 16 μm, 18 μm, 20 μm, etc., which is not specifically limited in this embodiment.

One of the innovative points of this embodiment is that the second insulating layer 13 has the gap 13a distributed on the peripheral side of the electrode layer 12, and the gap 13a is filled with the low dielectric constant medium 14. This is also one of the differences between this embodiment and an existing horizontal inductor 100. Taking the existing horizontal inductor as a comparative example, various parameters of the inductor are tested, and the experimental data are shown in Table 1 and FIG. 4 (FIG. 4 is a comparison diagram of the impedance spectra between the comparative example and the embodiment, where the horizontal coordinate is frequency and the vertical coordinate is impedance in FIG. 4).

TABLE 1
Parameter Comparison between Comparative
Example and Embodiment

| | Comparative | | Improvement |
|---|---|---|---|
| Parameters | example | Embodiment | ratio |
| Size (Length × Width × | 2.0 × | 2.0 × | Exactly the |
| Height/Unit: mm) | 1.25 × 0.85 | 1.25 × 0.85 | same |
| Impedance (@100 MHz/Unit: | 55 | 50 | −10% |
| Ω) | | | |
| Self-resonant frequency SRF | 655 | 1200 | +83% |
| (Unit: MHz) | | | |
| Bandwidth(Z > 70Ω/Unit: | 831 | 2213 | +166% |
| MHz) | | | |
| DC resistance DCR (Unit: | 7 | 7 | Exactly the |
| mΩ) | | | same |
| Temperature rise current | 6 | 6 | Exactly the |
| (Unit: A) | | | same |

It can be seen from Table 1 and FIG. 4 that, under the premise of the same size, the inductor 100 of the embodiment has significantly improved self-resonant frequency and bandwidth compared with the comparative example. Except for a slight decrease in low-frequency impedance, other parameters are exactly the same, and the high-frequency impedance is also improved. That is, although adopting the existing horizontal structure, the inductor 100 of the embodiment can maintain high current, a relatively simple structure and high manufacturing yield, under the premise of no degradation of other indicators, by filling the low-dielectric-constant medium 14, the inductor 100 of the embodiment achieves a significant improvement in self-resonant frequency and bandwidth.

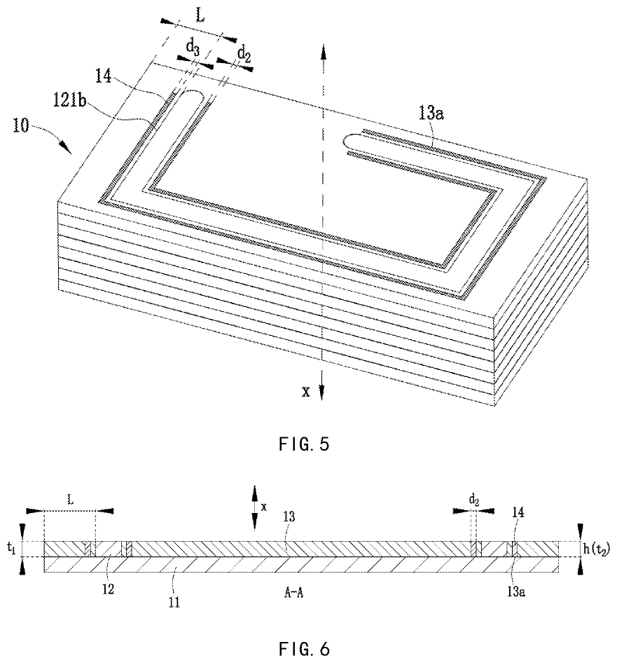

Optionally, as shown in FIGS. 3 and 5, the electrode layer 12 is configured in a winding shape extending around a straight line in the stacking direction x of the multiple base layers 10a. The peripheral side surface 121 of the electrode layer 12 includes an inner side surface 121a and an outer side surface 121b opposite to each other. The inner side surface 121a is arranged to toward the straight line along the stacking direction x. The gap 13a is distributed on the inner peripheral side of the electrode layer 12, and the distance from the gap 13a to the inner side surface 121a of the electrode layer 12 is d1; and/or the gap 13a is distributed on the outer peripheral side of the electrode layer 12, and the distance from the gap 13a to the outer side surface 121b of the electrode layer 12 is d1. Thus, this embodiment provides three distribution modes of the gap 13a, which are distributed on the inner peripheral side of the electrode layer 12, on the outer peripheral side of the electrode layer 12, and on both the inner and outer peripheral sides of the electrode layer 12, respectively. The improvement amplitudes of the self-resonant frequency and bandwidth of the inductor 100 vary according to different distribution modes, which can be selected according to actual conditions and are not specifically limited in this embodiment.

As an example, the electrode layer 12 is configured in a winding shape extending around a straight line along the stacking direction x of the base layers 10a, and the gap 13a extends along the extension direction of the electrode layer 12. The extension length of the gap 13a is greater than or equal to ten percent of the extension length of the electrode layer 12. If the extension length of the gap 13a is less than ten percent of the extension length of the electrode layer 12, the extension length of the gap 13a is relatively small, the overall volume and proportion of the gap 13a are relatively low, the volume of the low dielectric constant medium 14 that can be filled in the gaps 13a is relatively small, and the improvement amplitudes of the self-resonant frequency and bandwidth of the inductor 100 are relatively small. Therefore, the extension length of the gap 13a can be greater than or equal to ten percent of the extension length of the electrode layer 12, so that the overall volume and proportion of the gap 13a are large, the volume of the low dielectric constant medium 14 that can be filled in the gaps 13a is large, and the improvement amplitudes of the self-resonant frequency and bandwidth of the inductor 100 are large. And the extension length of the gap 13a can be 10%, 20%, 30%, 40%, 50%, 60%, 70%, 80%, 90%, 100% of the extension length of the electrode layer 12, etc., which is not specifically limited in this embodiment.

In some embodiments, the electrode layer 12 is configured in a winding shape extending around a straight line along the stacking direction x of the base layers 10a, and the gap 13a extend from one end of the electrode layer 12 to the other end of the electrode layer 12 along the extension direction of the electrode layer 12. In this way, the extension length of the gap 13a is approximately equal to that of the electrode layer 12, and the gap 13a extend continuously and uninterruptedly, so that under the condition that other dimensions of the gap 13a are the same, the volume of the gap 13a can be relatively large as much as possible, the volume of the low dielectric constant medium 14 that can be filled in the gaps 13a is relatively large, and the self-resonant frequency and bandwidth of the inductor 100 can be further improved.

In other embodiments, the gap 13a may be discontinuous and intermittent, that is, multiple gap sections of the gap 13a are arranged at intervals in sequence along the extension direction of the electrode layer 12, which is not specifically limited in this embodiment. Compared with the continuous and uninterrupted extension mode, the discontinuous and intermittent gaps 13a have a lower overall volume proportion, and the effect of improving the self-resonant frequency and bandwidth of the inductor 100 is poorer.

As an example, as shown in FIG. 5, the electrode layer 12 is configured in a winding shape extending around a straight line along the stacking direction x of the base layers 10a. The peripheral side surface 121 of the electrode layer 12 includes an outer side surface 121b arranged in a direction facing away from the straight line along the stacking direction x. The margin between the outer side surface 121b and the surface of the main body 10 is L, and the width of the gap 13a along the peripheral side direction of the electrode layer 12 is d2, where 0.1 L≤d2≤ 0.8L. If the width d2 of the gap 13a along the peripheral side direction of the electrode layer 12 is less than 0.1 L, the width d2 is relatively small, the volume of the low-dielectric-constant medium 14 that can be filled in the gap 13a is relatively small, and the improvement amplitudes of the self-resonant frequency and bandwidth of the inductor 100 are relatively small. If the width d2 of the gap 13a along the peripheral side direction of the electrode layer 12 is greater than 0.8 L, the width d2 is relatively large, and there is a risk of cracking at the gap 13a. For example, when the main body 10 is subjected to warm water isostatic pressing, the stress at the gaps 13a is large, and there is a risk of cracking resulting from the arising of an extension, which will result in low manufacturing yield. Therefore, the width d2 of the gap 13a along the peripheral side direction of the electrode layer 12 can be set to 0.1 L≤d2≤0.8 L, so that the volume of the low-dielectric-constant medium 14 that can be filled in the gaps 13a is relatively large, the improvement amplitudes of the self-resonant frequency and bandwidth of the inductor 100 are relatively large, cracking at the gaps 13a can be avoided, and the manufacturing yield is relatively high. And the width d2 of the gap 13a along the peripheral side direction of the electrode layer 12 can be 0.1 L, 0.2 L, 0.3 L, 0.4 L, 0.5 L, 0.6 L, 0.7 L, 0.8 L, etc., which is not specifically limited in this embodiment.

For example, the width d2 of the gap 13a along the peripheral side direction of the electrode layer 12 in this embodiment is preferably 0.5 L.

Optionally, as shown in FIG. 6, the thickness of the electrode layer 12 along the stacking direction x of the multiple base layers 10a is t1, and the depth of the gaps 13a along the stacking direction x is h, where 0.1 t1≤h≤1.5 t1. If the depth h of the gap 13a along the stacking direction x is less than 0.1 t1, the depth h is relatively small, the volume of the low-dielectric-constant medium 14 that can be filled in the gaps 13a is relatively small, and the improvement amplitudes of the self-resonant frequency and bandwidth of the inductor 100 are relatively small. If the depth h of the gaps 13a along the stacking direction x is greater than 1.5 t1, the depth h is relatively large, the thickness of the second insulating layer 13 is relatively large, and under the condition that the overall thickness of the base layers 10a remains unchanged, the thickness of the first insulating layer 11 is relatively small, the distance between the electrode layers 12 of two adjacent base layers 10a is relatively small, and the insulation effect of the first insulating layer 11 is relatively poor. Therefore, the depth h of the gap 13a along the stacking direction x can be set to 0.1 t1≤h≤ 1.5t1, so that the volume of the low-dielectric-constant medium 14 that can be filled in the gap 13a is relatively large, the improvement amplitudes of the self-resonant frequency and bandwidth of the inductor 100 is relatively large, the thickness of the first insulating layer 11 is relatively large, the distance between the electrode layers 12 of two adjacent base layers 10a is relatively large, and the insulation effect of the first insulating layer 11 is relatively good. The depth h of the gap 13a along the stacking direction x can be 0.1 t1, 0.3 t1, 0.5 t1, 0.7 t1, 0.9 t1, t1, 1.1 t1, 1.3 t1, 1.5 t1, etc., which is not specifically limited in this embodiment.

For example, the depth h of the gaps 13a along the stacking direction x in this embodiment is preferably t1.

The dielectric constant of the low dielectric constant medium 14 is ε, where 1≤E≤14, which can be selected according to actual conditions. The dielectric constant ε of the low dielectric constant medium 14 can be 1, 3, 5, 7, 9, 11, 13, 14, etc., which is not specifically limited in this embodiment.

In some embodiments, the materials of the low dielectric constant medium 14 include one or more of glass, ceramic, and air. This embodiment provides a variety of materials for the low dielectric constant medium, which can be selected according to actual conditions and are not specifically limited in this embodiment.

As an example, the materials of the low dielectric constant medium 14 include one or both of glass and ceramic. In this way, the low dielectric constant medium 14 is solid, and its shape matches the shape of the gap 13a.

When the materials of the low dielectric constant medium 14 includes one or both of glass and ceramic, the dimensions of the low dielectric constant medium 14 are as follows:

Optionally, the thickness of the electrode layer 12 along the stacking direction x of the multiple base layers 10a is t1, and the thickness of the low dielectric constant medium 14 along the stacking direction x is t2, where 0.1 t1≤t2≤1.5 t1. If the thickness t2 of the low dielectric constant medium 14 along the stacking direction x is less than 0.1 t1, the thickness t2 is relatively small, the volume of the low dielectric constant medium 14 is relatively small, and the improvement amplitudes of the self-resonant frequency and bandwidth of the inductor 100 are relatively small. If the thickness t2 of the low-dielectric-constant medium 14 along the stacking direction x is greater than 1.5 t1, the thickness t2 is relatively large, the low dielectric constant medium 14 partially protrudes out of the gap 13a, or the thickness of the second insulating layer 13 is relatively large. Under the condition that the overall thickness of the base layer 10a remains unchanged, the thickness of the first insulating layer 11 is small, the distance between the electrode layers 12 of two adjacent base layers 10a is relatively small, and the insulation effect of the first insulating layer 11 is relatively poor. Therefore, the thickness t2 of the low dielectric constant medium 14 along the stacking direction x can be set to 0.1 t1≤t2≤1.5 t1, so that the volume of the low dielectric constant medium 14 is relatively large, the improvement amplitudes of the self-resonant frequency and bandwidth of the inductor 100 are relatively large, the thickness of the first insulating layer 11 is relatively large, the distance between the electrode layers 12 of two adjacent base layers 10a is relatively large, and the insulation effect of the first insulating layer 11 is relatively good. And the thickness t2 of the low dielectric constant medium 14 along the stacking direction x can be 0.1 t1, 0.3 t1, 0.5 t1, 0.7 t1, 0.9 t1, 1.1 t1, 1.3 t1, and 1.5 t1, etc., which is not specifically limited in this embodiment.

For example, the thickness t2 of the low dielectric constant medium 14 along the stacking direction x in this embodiment is preferably t1.

In some embodiments, as shown in FIG. 5, the electrode layer 12 is configured in a winding shape extending around a straight line along the stacking direction x of the base layers 10a. The peripheral side surface 121 of the electrode layer 12 includes an outer side surface 121b, the margin between the outer side surface 121b and the surface of the main body 10 is L, and the width of the low dielectric constant medium 14 along the peripheral side direction of the electrode layer 12 is d3, where 0.1 L≤d3≤0.8 L. If the width d3 of the low dielectric constant medium 14 along the peripheral side direction of the electrode layer 12 is less than 0.1 L, the width d3 is relatively small, the volume of the low-dielectric-constant medium 14 is relatively small, and the improvement amplitudes of the self-resonant frequency and bandwidth of the inductor 100 are relatively small. If the width d3 of the low-dielectric-constant medium 14 along the peripheral side direction of the electrode layer 12 is greater than 0.8 L, the width d3 is relatively large, and there is a risk of cracking at the low dielectric constant medium 14. For example, when the main body 10 is subjected to warm water isostatic pressing, the stress at the low dielectric constant medium 14 is relatively large, and there is a risk of cracking resulting from the arising of an extension, which will result in low manufacturing yield. Therefore, the width d3 of the low dielectric constant medium 14 along the peripheral side direction of the electrode layer 12 can be set to 0.1 L≤d3≤0.8 L, so that the volume of the low dielectric constant medium 14 is relatively large, the improvement amplitudes of the self-resonant frequency and bandwidth of the inductor 100 are relatively large, cracking at the low dielectric constant medium 14 can be avoided, and the manufacturing yield is relatively high. Ant the width d3 of the low dielectric constant medium 14 along the peripheral side direction of the electrode layer 12 can be 0.1 L, 0.2 L, 0.3 L, 0.4 L, 0.5 L, 0.6 L, 0.7 L, and 0.8 L, etc., which is not specifically limited in this embodiment.

For example, the width d3 of the low dielectric constant medium 14 along the peripheral side direction of the electrode layer 12 in this embodiment is preferably 0.5 L.

One or more embodiments of the present disclosure provide an inductor 100, by disposing the electrode layer 12 and the second insulating layer 13 on the first insulating layer 11 of the base layers 10a, and disposing multiple base layers 10a in stacked layers in sequence, so that the electrode layer 12 of each base layer 10a is electrically connected in sequence to form the inner electrode 12a, and furthermore, by electrically connecting the first outer electrode 20 and the second outer electrode 30, which are respectively disposed at both ends of the main body 10, to the inner electrode 12a to achieve electrical conduction, that is, the inductor 100 is provided, which adopts a horizontal structure, has a large current, a relatively simple structure and high manufacturing yield. Meanwhile, the gap 13a of the second insulating layer 13 is filled with the low dielectric constant medium 14 to reduce the parasitic capacitance between the inner electrode 12a and the first and second outer electrodes 20 and 30, so that the self-resonant frequency and bandwidth of the inductor 100 are improved. That is, the inductor 100 of this embodiment can achieve both high current and high self-resonant frequency, and has a wider impedance bandwidth, a relatively simple structure and a relatively high manufacturing yield.

In addition, the distance d1 from the gap 13a of the second insulating layer 13 to the peripheral side surface 121 of the electrode layer 12 is not less than 10 μm, so that part of the second insulating layer 13 can be used to separate the electrode layer 12 from the gap 13a, thereby preventing foreign matter (such as water vapor or plating solution during the manufacturing process) from entering the gap 13a and affecting the performance of the electrode layer 12, which results in a relatively high reliability of the inductor 100.

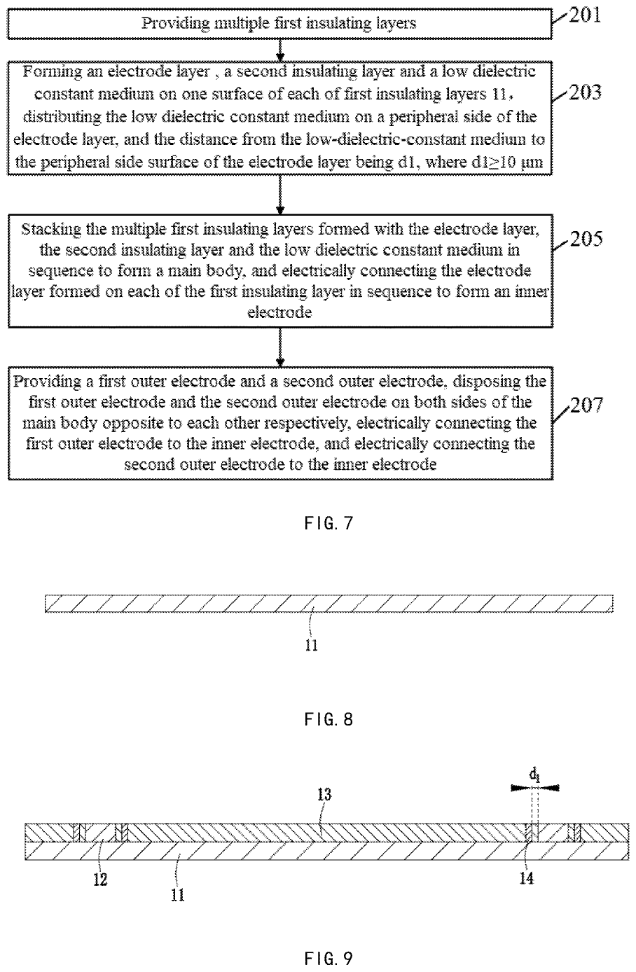

Please refer to FIG. 7, which is a schematic flow chart of a manufacturing method of an inductor provided in one or more embodiments of the present disclosure. The manufacturing method includes:

201, providing multiple first insulating layers 11.

Specifically, step 201 can be: forming a full roll of ferrite ceramic green tape on a PET (Polyethylene Glycol Terephthalate) film by tape casting, and cutting the ferrite ceramic green tape to form a single-layer green tape with a certain size, as shown in FIG. 8, that is, the first insulating layer 11.

203, forming an electrode layer 12, a second insulating layer 13 and a low dielectric constant medium 14 on one surface of each of the first insulating layers 11. The low dielectric constant medium 14 is distributed on the peripheral side of the electrode layer 12, and the distance from the low dielectric constant medium 14 to the peripheral side surface of the electrode layer 12 is d1, where d1≥10 μm.

As shown in FIG. 9, FIG. 9 shows the first insulating layer 11 formed with the electrode layer 12, the second insulating layer 13 and the low dielectric constant medium 14 after implementing step 203.

In this embodiment, the material of the low dielectric constant medium 14 in step 203 includes one or both of glass and ceramic. This embodiment provides a variety of different materials for the low dielectric constant medium, which can be selected according to actual conditions and are not specifically limited in this embodiment.

In this way, after the low dielectric constant medium 14 is formed in step 203, the compactness of the main body 10 formed in step 205 can be maintained throughout subsequent processing steps. Compared with the method of leaving a void (gap 13a) here without forming the low dielectric constant medium 14, the risk of cracking of the main body 10 can be reduced, and the manufacturing yield of the inductor is relatively high.

Specifically, forming the electrode layer 12 on one surface of the first insulating layer 11 can be: covering a conductive electrode material (such as silver, copper, and graphite, etc.) on the first insulating layer 11 to form the electrode layer 12.

Optionally, the process of covering the conductive electrode material on the first insulating layer 11 can be screen printing, vapor deposition, spin coating, or dry film pressing, etc., which is not specifically limited in this embodiment.

As an example, forming the second insulating layer 13 on one surface of the first insulating layer 11 can be: printing ferrite printing paste on the non-electrode area on the first insulating layer 11 (that is, the area where the electrode layer 12 is not formed).

Optionally, the process of forming the low dielectric constant medium 14 on the first insulating layer 11 can be screen printing, vapor deposition, spin coating, or dry film pressing, etc., which is not specifically limited in this embodiment.

There is no difference in the sequence of formation of the electrode layer 12, the second insulating layer 13 and the low-dielectric-constant medium 14, and the sequence of formation of the three can be changed according to actual conditions.

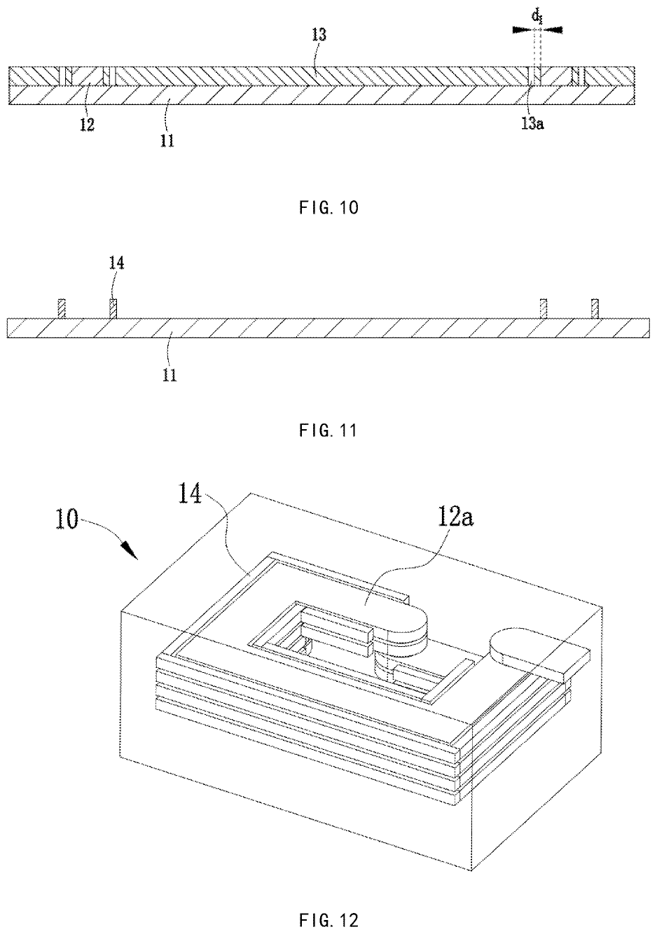

As an optional embodiment, step 203 can be: as shown in FIG. 10, forming the electrode layer 12 and the second insulating layer 13 on one surface of each of the first insulating layers 11. The second insulating layer 13 includes a gap 13a distributed on the peripheral side of the electrode layer 12 and the distance from the gap 13a to the peripheral side surface of the electrode layer 12 is d1, where d1>10 μm. As shown in FIG. 9, the gap 13a is filled with the low dielectric constant medium 14.

There is no difference in the sequence of formation of the electrode layer 12 and the second insulating layer 13, and the sequence of formation of the two can be changed according to actual conditions.

As another optional embodiment, step 203 can be: as shown in FIG. 11, forming the low dielectric constant medium 14 on one surface of each of the first insulating layers 11. As shown in FIG. 9, forming the electrode layer 12 and the second insulating layer 13 on one surface of each of the first insulating layers 11. The low dielectric constant medium 14 is distributed on the peripheral side of the electrode layer 12, the distance from the low-dielectric-constant medium 14 to the peripheral side surface of the electrode layer 12 is d1, where d1>10 μm, and the second insulating layer 13 is distributed on two opposite sides of the low-dielectric-constant medium 14.

There is no difference in the sequence in formation of the electrode layer 12 and the second insulating layer 13, and the sequence of formation the two can be changed according to actual conditions.

205, stacking the multiple first insulating layers 11 formed with the electrode layer 12, the second insulating layer 13 and the low dielectric constant medium 14 in sequence to form a main body 10, and the electrode layers 12 formed on each of the first insulating layers 11 is electrically connected in sequence to form an inner electrode.

As shown in FIG. 12, FIG. 12 shows the main body 10 formed after implementing step 205.

As an example, after step 205, the manufacturing method may include the following steps: warm water isostatic pressing, cutting, binder removal, sintering, and chamfering, etc. In this way, the main body 10 can be made denser and the overall strength of the main body 10 can be improved through warm water isostatic pressing. The main body 10 can be cut into multiple pieces according to a certain size by cutting. The organic matter (such as adhesive) present in the first insulating layer 11 and the second insulating layer 13 can be removed by binder removal, so that the main body 10 is denser and the overall strength of the main body 10 is improved. The main body 10 can be made magnetic and the strength of the main body 10 can be improved by sintering. Chamfering refers to forming rounded corners on the main body 10.

207, providing a first outer electrode and a second outer electrode, disposing the first outer electrode and the second outer electrode on two opposite sides of the main body 10 respectively, electrically connecting the first outer electrode to the inner electrode, and electrically connecting the second outer electrode to the inner electrode.

As an example, after step 207, the manufacturing method may include the following step: electroplating the first outer electrode and the second outer electrode, so as to form solder joints on the first outer electrode and the second outer electrode for electrical conduction between the inductor and other components.

By adopting the manufacturing methods of the one or more embodiments, the inductors of one or more embodiments can be manufactured. The gap of the manufactured inductor is filled with a low dielectric constant medium, and the materials of the low dielectric constant medium include one or both of glass and ceramic.

In addition, the inductors manufactured by the manufacturing method of the one or more embodiments provide the beneficial effects of the inductors of the one or more embodiments. For example, the manufacturing methods of one or more embodiments can manufacture the inductors with the same dimensional parameters (such as the thickness and width of the low dielectric constant medium, and so on) as the one or more embodiments. That is, the structure and the dimensions of the manufactured inductor can refer to one or more embodiments, which will not be repeated in this embodiment.

One or more embodiments of the present disclosure provide a manufacturing method of an inductor. The inductor manufactured by the manufacturing method can achieve both high current and high self-resonant frequency, and provide a relatively wide impedance bandwidth, a relatively simple structure and a relatively high manufacturing yield.

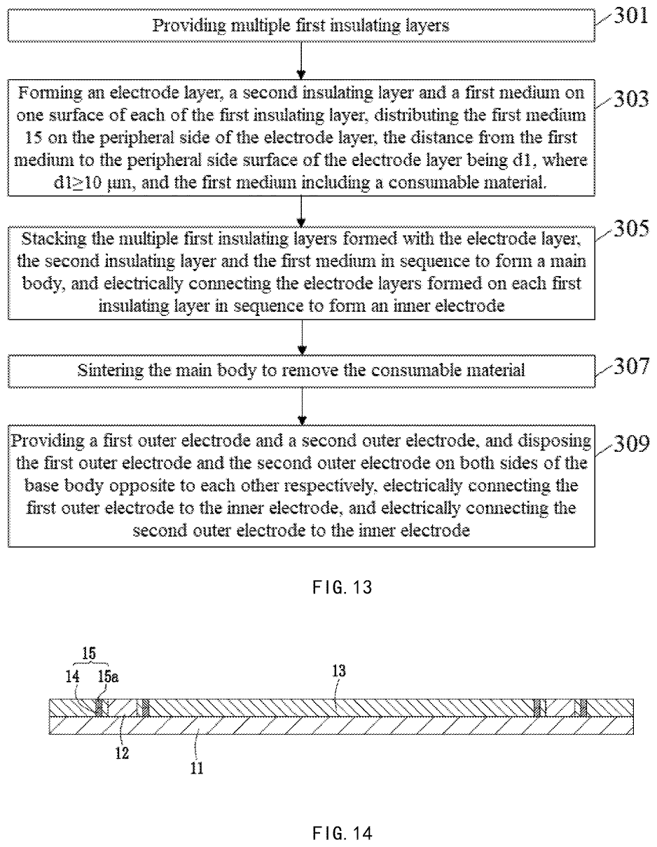

Please refer to FIG. 13, which is a schematic flow chart of manufacturing method of another kind of inductor provided in one or more embodiments of the present disclosure. The manufacturing method includes:

301, providing multiple first insulating layers 11.

Specifically, step 301 can be: forming a full roll of ferrite ceramic green tape on a PET (Polyethylene Glycol Terephthalate) film by tape casting, and cutting the ferrite ceramic green tape to form a single-layer green tape with a certain size, as shown in FIG. 8, that is, the first insulating layer 11.

303, forming an electrode layer 12, a second insulating layer 13 and a first medium 15 on one surface of each of the first insulating layers 11. The first medium 15 is distributed on the peripheral side of the electrode layer 12, and the distance from the first medium 15 to the peripheral side surface of the electrode layer 12 is d1, where d1≥10 μm. The first medium 15 includes a consumable material 15a.

As shown in FIG. 14, FIG. 14 shows the first insulating layer 11 formed with the electrode layer 12, the second insulating layer 13 and the first medium 15 after implementing step 303.

As an example, the consumable material 15a can include substances that can volatilize at high temperatures, such as resin, and so on. In this way, during sintering in the subsequent process, the consumable material 15a can be removed, so that a void a is formed at the original position of the consumable material 15a. The void a is filled with air, which has a low dielectric constant and can improve the self-resonant frequency and bandwidth of the inductor.

In some embodiments, the first medium 15 further includes a low dielectric constant medium 14. Optionally, the materials of the low dielectric constant medium 14 include one or both of glass and ceramic. This embodiment provides a variety of different materials for the low dielectric constant medium, which can be selected according to actual conditions and are not specifically limited in this embodiment.

In this way, during sintering in the subsequent process, the consumable material 15a can be removed while the low dielectric constant medium 14 is retained. The air filled in the void a formed at the original position of the consumable material 15a and the low dielectric constant medium 14 can jointly improve the self-resonant frequency and bandwidth of the inductor.

In addition, after the low dielectric constant medium 14 is formed in step 303, the compactness of the main body formed in step 305 can always be maintained before proceeding to the subsequent processing step of sintering. Compared with the method of leaving a void (gap) without forming the low-dielectric-constant medium 14, the risk of cracking of the main body can be reduced, and the manufacturing yield of the inductor is high.

Specifically, forming the electrode layer 12 on one surface of the first insulating layer 11 can be: covering a conductive electrode material (such as silver, copper, and graphite, etc.) on the first insulating layer 11 to form the electrode layer 12.

Optionally, the process of covering the conductive electrode material on the first insulating layer 11 can be screen printing, vapor deposition, spin coating, or dry film pressing, etc., which is not specifically limited in this embodiment.

As an example, forming the second insulating layer 13 on one surface of the first insulating layer 11 can be: printing ferrite printing paste on the non-electrode area on the first insulating layer 11 (that is, the area where the electrode layer 12 is not formed).

Optionally, the process of forming the first medium 15 on the first insulating layer 11 can be screen printing, vapor deposition, spin coating, or dry film pressing, etc., which is not specifically limited in this embodiment.

There is no difference in the sequence of formation of the electrode layer 12, the second insulating layer 13 and the first medium 15, and the sequence of formation of the three can be changed according to actual conditions.

As an optional embodiment, step 303 can be: forming the electrode layer 12 and the second insulating layer 13 on one surface of each first insulating layer 11. The second insulating layer 13 includes a gap distributed on the peripheral side of the electrode layer 12, and the distance from the gap to the peripheral side surface of the electrode layer 12 is d1, where d1≥10 μm. The gap is filled with the first medium 15.

There is no difference in the sequence of formation of the electrode layer 12 and the second insulating layer 13, and the sequence of formation of the two can be changed according to actual conditions.

As another optional embodiment, step 303 can be: forming the first medium 15 on one surface of each of the first insulating layer 11s, forming the electrode layer 12 and the second insulating layer 13 on one surface of each of the first insulating layers 11. The first medium 15 is distributed on the peripheral side of the electrode layer 12, the distance from the first medium 15 to the peripheral side surface of the electrode layer 12 is d1, where d1≥10 μm, and the second insulating layer 13 is distributed on both sides of the first medium 15 opposite to each other.

There is no difference in the sequence of formation of the electrode layer 12 and the second insulating layer 13, and the sequence of formation of the two can be changed according to actual conditions.

305, stacking the multiple first insulating layers 11 formed with the electrode layer 12, the second insulating layer 13 and the first medium 15 in sequence to form a main body, and the electrode layers 12 formed on each of the first insulating layers 11 is electrically connected in sequence to form an inner electrode.

As an example, after step 305, the manufacturing method may include the following steps: warm water isostatic pressing, cutting, and binder removal.

307, sintering the main body to remove the consumable material 15a. In this way, the main body is made magnetic and the strength of the main body is improved by sintering, while the heat of sintering can be used to volatilize the consumable material 15a, so as to remove the consumable material 15a, achieving two purposes through one step.

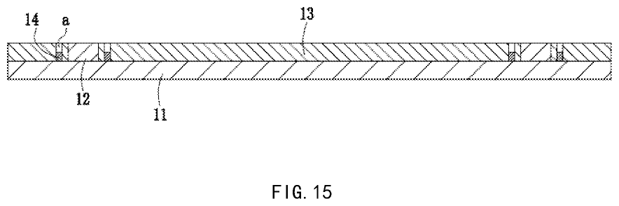

As shown in FIG. 15, FIG. 15 shows the main body after implementing step 307 (some base layers are omitted). Compared with FIG. 14, the consumable material 15a in FIG. 14 is volatilized and removed during sintering, and the position of the consumable material 15a forms a void a.

As an example, after step 307, the manufacturing method may include chamfering.

309. Providing a first outer electrode and a second outer electrode, and disposing the first outer electrode and the second outer electrode on two sides of the main body opposite to each other respectively. The first outer electrode is electrically connected to the inner electrode, and the second outer electrode is electrically connected to the inner electrode.

As an example, after step 309, the manufacturing method may include the following step: electroplating the first outer electrode and the second outer electrode, so as to form solder joints on the first outer electrode and the second outer electrode for electrical conduction between the inductor and other components.

By adopting the manufacturing method of one or more embodiments, the inductors of one or more embodiments can be manufactured. The gap of the manufactured inductor is filled with a low-dielectric-constant medium and air, and the materials of the low dielectric constant medium include one or both of glass and ceramic.

In addition, the inductors manufactured by the manufacturing methods of one or more embodiments provide the beneficial effects of the inductors of one or more embodiments. For example, the manufacturing method of one or more embodiments can manufacture inductors with the same dimensional parameters (such as the thickness and width of the low-dielectric-constant medium) as one or more embodiments. That is, the structure and dimensions of the manufactured inductor can refer to one or more embodiments, which will not be repeated in this embodiment. The main difference between the inductors manufactured by the manufacturing method of one or more embodiments and the inductors manufactured by the manufacturing method of one or more embodiments is in that the substances filled in the gap of the inductor are different. The gap of the inductor manufactured by one or more embodiments is filled with air, while there is no air in the gap of the inductor manufactured by one or more embodiments.

One or more embodiments of the present disclosure provide a manufacturing method of an inductor. The inductor manufactured by the manufacturing method can achieve both high current and high self-resonant frequency, and has a relatively wide impedance bandwidth, a relatively simple structure and a relatively high manufacturing yield.

The technical features in the above embodiments may be combined arbitrarily. For brevity of description, not all possible combinations of the technical features in the above embodiments are described. However, combinations of these technical features that do not contradict each other shall be deemed to fall within the scope described in this specification.

The above embodiments only express several implementation modes of the present disclosure. Although the descriptions are relatively specific and detailed, they shall not be construed as limitations on the scope of the invention patent. It should be noted that a person of ordinary skill in the art may make several modifications and improvements without departing from the concept of the present disclosure, and these all fall within the protection scope of the present disclosure. Therefore, the protection scope of the present disclosure patent shall be subject to the appended claims.

The inductor and the preparation method thereof provided by the present disclosure enable the inductor to have both high current and high self-resonant frequency, as well as a relatively wide impedance bandwidth, a relatively simple structure and a relatively high preparation yield, thus possessing strong industrial applicability.

What is claimed is:

1. An inductor, comprising:
a main body, wherein the main body comprises multiple base layers stacked in sequence, each of the base layers comprises a first insulating layer, an electrode layer, and a second insulating layer, the electrode layer is disposed on the first insulating layer, the electrode layer of each of the base layers is electrically connected in sequence to form an inner electrode, the second insulating layer is disposed on the first insulating layer and located on the same surface of the first insulating layer as the electrode layer, the second insulating layer comprises a gap, the gap is distributed on a peripheral side of the electrode layer, and the gap is filled with a low dielectric constant medium;
a first outer electrode is disposed at one end of the main body, the first outer electrode is electrically connected to the inner electrode; and
a second outer electrode is disposed at an end of the main body opposite to the first outer electrode, the second outer electrode is electrically connected to the inner electrode.

2. The inductor according to claim 1, wherein the electrode layer is configured in a winding shape extending around a straight line in a stacking direction of the base layers, the gap extends along an extending direction of the electrode layer, and an extending length of the gaps is greater than or equal to ten percent of an extending length of the electrode layer.

3. The inductor according to claim 1, wherein the electrode layer is configured in a winding shape extending around a straight line in a stacking direction of the base layers, and the gap extends from one end of the electrode layer to the other end of the electrode layer along an extending direction of the electrode layer.

4. The inductor according to claim 1, wherein a distance from the gap to the peripheral side surface of the electrode layer is d1, wherein d1≥10 μm.

5. The inductor according to claim 1, wherein the electrode layer is configured in a winding shape extending around a straight line in a stacking direction of the base layers, the peripheral side surface of the electrode layer comprises an outer side surface disposed in a direction facing away from the straight line in the stacking direction, a margin between the outer side surface and a surface of the main body is L, and a width of the gap along a peripheral side direction of the electrode layer is d2, wherein 0.1 L≤d2≤0.8 L.

6. The inductor according to claim 1, wherein the electrode layer is configured in a winding shape extending around a straight line in a stacking direction of the multiple base layers, the peripheral side surface of the electrode layer comprises an inner side surface and an outer side surface opposite to each other, the inner side surface is disposed in a direction facing toward the straight line in the stacking direction, the gap is distributed on an inner peripheral side of the electrode layer, a distance from the gap to the inner side surface of the electrode layer is d1, and/or the gap is distributed on an outer peripheral side of the electrode layer, a distance from the gap to the outer side surface of the electrode layer is d1.

7. The inductor according to claim 1, wherein a thickness of the electrode layer along a stacking direction of the multiple base layers is t1, and a depth of the gap along the stacking direction is h, wherein 0.1 t1≤h≤1.5 t1.

8. The inductor according to claim 1, wherein materials of the low dielectric constant medium comprise one or more of glass, ceramic, and air.

9. The inductor according to claim 8, wherein when the materials of the low-dielectric-constant medium comprise one or both of glass and ceramic, the thickness of the electrode layer along the stacking direction of the multiple base layers is t1, and the thickness of the low dielectric constant medium along the stacking direction is t2, wherein 0.1 t1≤t2≤1.5 t1.

10. The inductor according to claim 8, wherein when the material of the low-dielectric-constant medium comprise one or more of glass and ceramic, the peripheral side surface of the electrode layer comprises an outer side surface disposed away from the straight line in the stacking direction, a margin between the outer side surface and the surface of the main body is L, a width of the low-dielectric-constant medium along the peripheral side direction of the electrode layer is d3, wherein 0.1 L≤d3≤0.8 L.

11. A method for manufacturing an inductor, comprising:
providing multiple first insulating layers;
forming an electrode layer, a second insulating layer, and a low dielectric constant medium on one surface of each of the first insulating layers, wherein the low dielectric constant medium is distributed on a peripheral side of the electrode layer;
stacking the multiple first insulating layers formed with the electrode layer, the second insulating layer, and the low dielectric constant medium in sequence to form a main body, wherein the electrode layer formed on each of the first insulating layers is electrically connected in sequence to form an inner electrode;
providing a first outer electrode and a second outer electrode, and disposing the first outer electrode and the second outer electrode on two opposite sides of the main body respectively, wherein the first outer electrode is electrically connected to the inner electrode, and the second outer electrode is electrically connected to the inner electrode.

12. The manufacturing method according to claim 11, wherein the forming an electrode layer, a second insulating layer, and a low-dielectric-constant medium on one surface of each of the first insulating layers, wherein the low-dielectric-constant medium is distributed on the peripheral side of the electrode layer, comprises:
forming the electrode layer and the second insulating layer on one surface of each of the first insulating layers, wherein the second insulating layer comprises a gap, the gap is distributed on the peripheral side of the electrode layer, a distance from the gap to the peripheral side surface of the electrode layer is d1, wherein d1≥10 μm; and
filling the gap with the low dielectric constant medium.

13. The manufacturing method according to claim 11, wherein materials of the low dielectric constant medium comprise one or more of glass, ceramic and air.

14. The manufacturing method according to claim 12, wherein materials of the low dielectric constant medium comprise one or more of glass and ceramic.

15. A method for manufacturing an inductor, comprising:
providing multiple first insulating layers;
forming an electrode layer, a second insulating layer, and a first medium on one surface of each of the first insulating layers, wherein the first medium is distributed on a peripheral side of the electrode layer, and the first medium comprises a consumable material;
stacking the multiple first insulating layers formed with the electrode layer, the second insulating layer, and the first medium in sequence to form a main body, wherein the electrode layer formed on each of the first insulating layers is electrically connected in sequence to form an inner electrode;
sintering the main body to remove the consumable material; and
providing a first outer electrode and a second outer electrode, and disposing the first outer electrode and the second outer electrode on two opposite sides of the main body respectively, wherein the first outer electrode is electrically connected to the inner electrode, and the second outer electrode is electrically connected to the inner electrode.

16. The manufacturing method according to claim 15, wherein the forming an electrode layer, a second insulating layer, and a first medium on one surface of each of the first insulating layers, wherein the first medium is distributed on a peripheral side of the electrode layer, comprises:
forming the electrode layer and the second insulating layer on one surface of each of the first insulating layers, wherein the second insulating layer comprises a gap, the gap is distributed on the peripheral side of the electrode layer, a distance from the gaps to the peripheral side surface of the electrode layer is d1, wherein d1≥10 μm; and
filling the gap with the first medium.

17. The manufacturing method according to claim 15, wherein the first medium further comprises a low dielectric constant medium.

18. The manufacturing method according to claim 16, wherein the first medium further comprises a low dielectric constant medium.

19. The manufacturing method according to claim 17, wherein materials of the low dielectric constant medium comprise one or more of glass, ceramic and air.
